(19) United States
(12) Patent Application Publication
(10) Pub. No.: US 2025/0018672 A1
(43) Pub. Date: Jan. 16, 2025

(54) DIRECT INJECTION FOOTWEAR MOULD ASSEMBLY AND DIRECT INJECTION FOOTWEAR BOTTOM MOULD ASSEMBLY

(71) Applicant: ECCO Sko A/S, Bredebro (DK)

(72) Inventor: Jens Sonne Mortensen, Bredebro (DK)

(21) Appl. No.: 18/710,496

(22) PCT Filed: Nov. 15, 2022
(86) PCT No.: PCT/DK2022/050240

§ 371 Date: May 15, 2024

(30) Foreign Application Priority Data
Nov. 15, 2021 (DK) PA202170560

(51) Int. Cl. B29D 35/00; B33Y 80/00

(52) U.S. Cl. CPC B29D 35/0036; B33Y 80/00

(57) ABSTRACT

A direct injection footwear mold assembly includes two side basic molds and a bottom basic mold. The bottom basic mold includes a bottom mold attachment arrangement. The bottom basic mold has a transverse direction, a longitudinal direction, and a vertical direction. The attachment arrangement of the bottom basic mold is arranged to fixate a bottom mold insert in the vertical direction to the bottom basic mold.

### FIELD OF THE INVENTION

The invention relates to a direct injection footwear mould assembly, a direct-injection footwear bottom mould assembly and a method of manufacturing footwear in a direct injection manufacturing station of an injection moulding equipment for manufacturing of footwear.

### BACKGROUND OF THE INVENTION

The invention relates to direct injection manufacturing of footwear.

Advantages of a direct injection process (DIP) for attachment of soles to footwear are many.

One such system is described in US 2019/0073709 A1, disclosing so-called hybrid moulds comprising of outer mould shells and associated inner moulds.

A challenge with the disclosed hybrid mould is however that the disclosed moulds may be expensive in use as they are not as reliable in a DIP process as conventional DIP non-hybrid moulds.

A further example of direct injection production of footwear is described by WO 2020/182259 A1, wherein a mould configured for direct injection production of footwear is described. This mould comprises two basic side moulds and a basic bottom mould, each configured to be provided with e.g. 3D printed inserts. The basic bottom mould may be provided with basic bottom coupling elements adapted to mate with bottom insert coupling elements for positioning. The coupling elements may be adapted to hold the bottom insert in position relative to the basic bottom mould while the footwear injection mould is moved from an open position towards its closed position and during the injection moulding process.

Even further, WO 2020/182261 A1 describes a moulding system with two basic side moulds and a basic bottom mould, each configured to be provided with e.g. 3D printed inserts. The bottom insert of this prior art system may be coupled to the basic bottom mould by means of coupling elements for positioning.

### SUMMARY OF THE INVENTION

The invention relates to a direct injection footwear mould assembly comprising two side basic moulds (SBM1, SBM2) and a bottom basic mould (BM), said bottom basic mould including a bottom mould attachment arrangement, the bottom basic mould having a transverse direction (v), a longitudinal direction (x) and a vertical direction (z), and the attachment arrangement of the bottom basic mould being arranged to fixate a bottom mould insert in the vertical direction to the bottom basic mould.

According to embodiments of the invention it is possible to fixate the bottom mould inserts to the bottom mould and thereby keep control of the bottom mould insert during manufacturing of the footwear.

In an embodiment of the invention one or more fixation points (with respect to the vertical direction of the bottom mould) may facilitate the bottom mould insert may stay in position during manufacturing.

In an embodiment of the invention one or more fixation points (with respect to the vertical direction of the bottom mould) may facilitate the bottom mould insert may stay in position during manufacturing, but also ensure the tensions in the bottom mould insert are counteracted and thereby keeping avoiding that the bottom mould insert changes shape during manufacturing due to heating of the bottom mould form.

This challenge is in particular an issue with 3D printed bottom mould inserts where the mould inserts are manufactured by moulded or preferably 3D printed polymers. The concept of fixating the bottom mould insert to the bottom mould has proven robust for the purpose of obtaining a reliable manufacturing process without damaging the applied mould inserts, e.g. by cracking or continuous repeated bending during opening and closing of the DIP moulds during manufacturing.

An attachment arrangement in the present context broadly refers to arrangement which will facilitate a locking of the bottom mould insert to the bottom mould, the locking being at least in the vertical direction. In some embodiment such a locking is both obtained with respect to the vertical (z-direction), longitudinal (x-direction) and transverse (y-direction) direction of the bottom mould.

An attachment arrangement is understood to facilitate releasable fixation of the bottom mould insert to the bottom mould with respect to at least the vertical direction, and in advantageous embodiments also in the transverse and longitudinal direction.

It is noted that in view of the prior art systems as disclosed by WO 2020/182259 A1 and WO 2020/182261 A1, the direct injection footwear mould assembly as provided by the invention provides an attachment arrangement that is arranged to fixate the bottom mould insert in the vertical direction, e.g. in a direction perpendicular to the plane of the bottom basic mould. Thereby, the bottom mould insert is maintained in its position abutting closely to the bottom basic mould and without e.g. bending or otherwise being misaligned with the intended mould position.

In an embodiment a direct injection footwear mould assembly is applied in a direct injection manufacturing station of an footwear injection moulding equipment where the moulds and the respective mould inserts are used to mould soles or sole parts onto footwear, by gathering the bottom mould and the side moulds (including respective mould inserts) together with the bottom of the footwear upper and thus forming a sole volume where injected sole material can be cured to form a sole on the respective footwear upper.

It is noted that as regards the basic direct injection mould, which can be attached to injection moulding equipment and is configured for channelling injection material to a mould cavity, it may be seen as being a moulding apparatus in itself, e.g. in that injection material may be injected from the injection moulding equipment via one or more channels and that the injected material via the one or more channels in the basic direct injection mould may be guided to a mould cavity defined by the basic direct injection mould itself. Further, though, by means of the direct injection mould inserts the mould cavity may be further defined, e.g. by providing mould surfaces covering at least partly the inner surfaces of the basic direct injection mould, and where e.g. a shoe upper may define the remaining mould surface.

It should generally be noted that DIP in the public domain may refer to both direct injection process or as sometime herein noted: direction injection production. Unless otherwise stated, DIP may in the present context refer both to a direct injection production and a direct injection process, and the present application does not distinguish between these two different references to the same process/production method.

Manufacturing of footwear by means of DIP in the present context may e.g. be performed by means of direction injection process/production equipment e.g. provided by the machine supplier Desma, e.g. by means of rotary table setups. The material applied for either 3D-printing last, last parts, mould, mould parts within the scope of the invention is unless otherwise noted referred to as additive manufacturing material, whereas the material applied in the footwear manufacturing process for soles in the direct injection production/process by means of the direct injection production/process equipment is referred to as injection material unless otherwise noted. Such injection material may typically be polyurethane or different modifications of polyurethane.

Also, it is noted that in case of any wear on the inserts that go beyond acceptable tolerances, the inserts may quickly and cost-efficiently be exchanged for new ones. This may be of importance for example in cases where the inserts have been made of material that has less wear resistance than conventionally used mould materials, e.g. metal, aluminium.

Thus, in general it will be seen that a more efficient manufacturing may be possible, where e.g. downtime may be avoided or at least reduced significantly as opposed to the prior art methods.

In an embodiment of the invention, each of the two side moulds may comprise a basic side mould and a respective side mould insert.

In an embodiment of the invention, each of the two side moulds may comprise a side mould attachment arrangement, the side mould attachment arrangements of the basic side mould being arranged to releasably fixate a respective side mould insert to the side basic mould.

In an embodiment of the invention, the bottom mould insert may be 3D printed.

When the bottom mould insert is 3D printed, the 3D material may tend to bend due to the temperature conditions during the direct injection process. The attachment arrangement should be strong enough to keep the mould insert in place and avoid bending of the insert or at least too much bending.

In an embodiment of the invention, the side mould inserts may be 3D printed.

In an embodiment of the invention the mould inserts, i.e. the bottom mould insert and the side mould inserts are 3D printed with additive manufacturing materials, e.g. printing materials, utilized by said additive manufacturing. In an embodiment these are 3D printed in additive manufacturing material comprising one or more polymers.

In an embodiment of the invention, said additive manufacturing materials, e.g. printing materials, utilized by said additive manufacturing, e.g. 3D printing may comprise one or more photopolymers

It should be noted that additive manufacturing materials in the present context thus in practice will refer to the material by means of which last, last parts, mould and or moulds parts are 3D printed.

In an embodiment of the invention, additive manufacturing materials, e.g. printing materials, utilized by said additive manufacturing, e.g. 3D printing, may comprise one from the list comprising polymers, resin photopolymers, ABS, PLA, ASA, nylon/nylon powder, PETG, metal/metal powder, plaster powder, HIPS, PET, PEEK, PVA, ULTEM, polyjet resin and/or ceramics and any combination thereof.

Hereby, it is possible to make advantage of a flexible material that do not break as easy as a rigid material. The heating may not be fully homogeneous e.g. from the bottom part the material may initially bend and in order not to break, the material should be able to withstand these inhomogeneous heating procedures.

In an embodiment of the invention, said additive manufacturing material, e.g. printing material, utilized by said additive manufacturing, e.g. 3D printing may comprise a material, that when cured, provides a surface that is adhesion defiant to the injected material.

Hereby, the moulding of the shoe soles may be made with less risk of faults due to e.g. injection material sticking to the inserts and the manufactured soles may be of a higher quality as regards the finish. Furthermore, it may be possible to reduce or even avoid application of anti-stick agents, lubrication or the like to the surfaces of the inserts, when using such materials that is adhesion defiant in relation to the injected material.

In an embodiment of the invention, said materials may comprise a reinforcement material.

In an embodiment of the invention said adhesion defiance may be obtained by use of
polyurethane as injection material and
one or more photopolymers as additive manufacturing material.

In an embodiment of the invention, said adhesion defiance may be obtained by use of
polyurethane as injection material and/or
additive manufacturing material, e.g. 3D material including the following, resin photopolymers, ABS, PLA, ASA, nylon/nylon powder, PETG, metal/metal powder, plaster powder, HIPS, PET, PEEK, PVA, ULTEM, polyjet resin and/or ceramics.

In an embodiment of the invention said adhesion defiance may be obtained by use of
polyurethane as injection material and
one or more photopolymers as additive manufacturing material.

In an embodiment of the invention, said adhesion defiance may be obtained by use of
polyurethane as injection material and/or
additive manufacturing material, e.g. 3D material including the following, resin photopolymers, ABS, PLA, ASA, nylon/nylon powder, PETG, metal/metal powder, plaster powder, HIPS, PET, PEEK, PVA, ULTEM, polyjet resin and/or ceramics.

It should be noted that the above use of polyurethane as injection material also may, to the degree that the direct injection process will allow it, be supplemented or substituted with rubber, e.g. natural or synthetic rubber completely or partly as direct injection material.

Natural rubber may e.g. be defined and understood according to the below explanations and may also be called India rubber or caoutchouc, as initially produced, comprises of polymers of the organic compound isoprene, with minor impurities of other organic compounds, plus water. Thailand and Indonesia are two of the leading rubber producers. Forms of polyisoprene that are used as natural rubbers are classified as elastomers.

Currently, rubber is harvested mainly in the form of the latex from the rubber tree or others. The latex is a sticky, milky colloid drawn off by making incisions in the bark and collecting the fluid in vessels in a process called “tapping”. The latex then is refined into rubber ready for commercial processing. In major areas, latex is allowed to coagulate in the collection cup. The coagulated lumps are collected and processed into dry forms for marketing.

Natural rubber is used extensively in many applications and products, either alone or in combination with other materials. In most of its useful forms, it has a large stretch ratio and high resilience, and is extremely waterproof.

Synthetic rubber is also well-known to the skilled person and may e.g. be understood according to the below explanation.

Like other polymers, synthetic may be made from various petroleum-based monomers. The most prevalent synthetic rubbers may be styrene-butadiene rubbers (SBR) derived from the copolymerization of styrene and 1,3-butadiene. Other synthetic rubbers are prepared from isoprene (2-methyl-1,3-butadiene, yielding polyisoprene), chloroprene (2-chloro-1,3-butadiene), and isobutylene (methylpropene) with a small percentage of isoprene for cross-linking (this product is called butyl rubber). These and other monomers can be mixed in various proportions to be copolymerized to produce products with a range of physical, mechanical, and chemical properties. The monomers can be produced pure, and the addition of impurities or additives can be controlled by design to give optimal properties. Polymerization of pure monomers can be better controlled to give a desired proportion of cis and trans double bonds.

Manufacturing technologies that may be used comprises Digital Light Processing (DLP), Stereolithography (SLA), Fused Deposition Modeling (FDM), Selective Laser Sintering (SLS), Material Jetting (MJ), Drop on Demand (DOD), Sand Binder Jetting, Metal Binder Jetting, direct Metal Laser Sintering (DMLS), Selective Laser Melting (SLM), Electron Beam Melting (EBM), LCD, polyjet and/or jet fusion.

In an embodiment of the invention, said bottom basic mould may be made by at least one metal, such as aluminium.

In an embodiment of the invention, said side basic moulds may be made by at least one metal, such as aluminium.

In an embodiment of the invention, the attachment arrangement of the bottom mould may comprise at least two fixation points.

In an embodiment of the invention two fixation points are obtained by bolting the bottom mould insert to the bottom basic mould at two distinct point. Three fixation points may also be applied. More fixation point may also be applied within the scope of the invention. Again, such discrete fixation point may be applied with nut and bolt keeping the bottom mould insert fixated to the bottom basic mould. The attachment of the bottom mould insert should be maintained as fixed during operation of the mould assembly in the direct injection manufacturing station of e.g. a DIP footwear rotary press. Preferably the fixation points should be enough to ensure that the bottom mould insert does not bend in the vertical (z-direction) direction, and therefore makes it possible to use the mould assembly in the DIP footwear injection machine without risking a bad and untight engagement between the mould inserts of the assembly and the footwear upper. Moreover, a continuous wear due to bending of the mould insert may be avoided or at least kept low to a degree that it is not critical due to continuous and repeated operation of the assembly in a footwear DIP machine.

In an embodiment of the invention, the distance between at least one point of fixation and a toe end of a bottom mould may be less than 10 cm and wherein the distance between at least one point of fixation and a heel end of a bottom mould may be less than 10 cm.

In an embodiment of the invention, the distance between at least one point of fixation and a toe end of a bottom mould may be less than 6 cm and wherein the distance between at least one point of fixation and a heel end of a bottom mould may be less than 6 cm.

In an embodiment of the invention, the distance between at least one point of fixation and a toe end of a bottom mould may be less than 5 cm and wherein the distance between at least one point of fixation and a heel end of a bottom mould may be less than 5 cm.

In an embodiment of the invention, the distance between at least one point of fixation and a toe end of a bottom mould may be less than 4 cm and wherein the distance between at least one point of fixation and a heel end of a bottom mould may be less than 4 cm.

In an embodiment of the invention, the distance between at least one point of fixation and a toe end of a bottom mould may be less than 3 cm and wherein the distance between at least one point of fixation and a heel end of a bottom mould may be less than 3 cm.

In an embodiment of the invention, the attachment arrangement of the bottom mould may comprise a plurality of fixation points.

In an embodiment of the invention a plurality of fixation points are used to obtain a secure fastening of the bottom mould insert to the basic bottom mould. Such plurality of fixation points may e.g. be obtained by providing a mutually fitting tongue and groove. E.g. a tongue formed in the bottom basic mould and a respective groove formed in the bottom mould insert, provided to facilitate that the bottom mould insert may be releasably fixated to the bottom basic mould, by sliding the groove of the bottom mould insert into the respective fitting tongue formed in the bottom basic mould.

Alternatively, a groove may be formed in the bottom basic mould and a respective tongue may be formed in the bottom mould insert, provided to facilitate that the bottom mould insert may be releasably fixated to the bottom basic mould, by sliding the tongue formed in the bottom mould insert into respective fitting groove formed in the bottom basic mould.

Several different configurations may be applied within the scope of the invention.

The groove and tongue may e.g. be inclined (still fitting to each other) or they may be parallel.

The groove may e.g. be dovetail type groove or any other suitable geometry.

It is noted that a plurality of fixation points may be e.g. two, three, four, five etc. discrete fixation points that are distributed longitudinally and/or transversely. Also, it is noted that a plurality of fixation points may be arranged linearly and/or curvilinearly.

In an embodiment of the invention, the attachment arrangement of the bottom mould may comprise a plurality of fixation points that forms part of a continuous and sequentially arranged fixations points.

In an embodiment of the invention, the fixation point may be provided by guide rails by means of which the bottom basic mould and the bottom mould insert are slided into each other, thereby providing a fixation of the bottom mould insert onto the bottom basic mould.

In an embodiment of the invention, the fixation points may be provided by a tongue of the bottom mould insert and a groove of the bottom basic mould or vice versa, said tongue and said groove being configured for mutually fitting and being slidingly engageable.

Hereby, the fixation in the vertical direction may be achieved in a convenient manner, whereby the bottom mould insert may be placed in the intended position in a user-friendly and easy manner, while still providing the desired fixation, e.g. by the tongue extending possibly along the whole length of the insert, for example in the longitudinal direction of the footwear. It is noted that the fixation may be effected by one or both sides of the tongue that cooperates with the groove. Also, it is noted that the bottom mould insert may be removed and replaced easily, for example when another footwear design has to be made or in case the insert must be replaced due to wear, in which case the insert in a relatively effortless manner may be pulled, pushed or otherwise removed from the groove, e.g. when the bottom basic mould has been moved downwards and/or when the side moulds have been moved away.

In an embodiment of the invention, said tongue and said groove may be configured having a width increasing towards the free end of the tongue.

Hereby, the fixation in the vertical direction may be achieved directly due to the geometry of the tongue and groove, when the tongue has been inserted into the groove.

In an embodiment of the invention, said tongue and said groove may be configured with a taper in a direction of sliding engagement with each other.

Hereby, various advantages may be achieved such as for example that the tongue may be stopped at a suitable position, destined by the taper geometry, and furthermore, an effective contact may be achieved between the walls of the groove and the surfaces of the tongue, thereby e.g. providing the possibility of transferring heat effectively between these parts, which may be advantageous during the footwear production that may incorporate injection of warm materials and materials that are relying on temperatures to be within certain intervals in order to result in a required end product.

In an embodiment of the invention, the fixation points may be obtained by means of threaded fasteners.

In an embodiment of the invention, the fixation points may be obtained by means of nut and bolt.

In an embodiment of the invention, the fixation points may be obtained by means of one of more snap-locks.

In an embodiment of the invention, the fixation points are distributed in the x and/or y direction of the bottom mould and the bottom mould insert.

The distribution of the fixation points in the x and/or y direction facilities a secure and reliable fastening of the bottom mould insert to the bottom basic mould and vertical bending across the area of the bottom basic mould may be kept in check.

In an embodiment, the fixation points may be distributed in the x and/or y direction of the basic bottom mould and the bottom mould insert such that a distance to the medial and/or lateral side of the basic bottom mould is at least 2 cm.

It is noted that the fixation points in the y direction may be positioned such that e.g. a distance to the medial and/or lateral side of the bottom mould is 2 cm or more, but it should be understood that fixation nearer to the medial and/or lateral side of the bottom mould may be utilized as well.

In an embodiment of the invention, the attachment arrangement of the bottom basic mould may be arranged to releasably fixate the bottom mould insert in the vertical direction to the bottom basic mould.

According to further embodiments, the attachment arrangement may be provided by means utilizing a vacuum effect.

According to further embodiments, the attachment arrangement may be provided by means utilizing a magnetic effect.

According to a further aspect, the invention relates to a direct-injection footwear bottom mould assembly comprising a bottom basic mould and a bottom mould insert, wherein the bottom insert is releasably fixated to the bottom basic mould by means of an attachment arrangement.

In an embodiment of the invention, the attachment arrangement is arranged to fixate the bottom mould insert in a direction perpendicular to the bottom basic mould.

According to an even further aspect, the invention relates to a method of manufacturing footwear in a direct injection manufacturing station, the method including the steps of
providing two basic side moulds and a bottom basic mould,
providing two side mould inserts and a bottom mould insert,
fixating the two side mould inserts to the respective two basic side moulds and thereby providing/forming two side mould assemblies,
fixating the bottom mould insert to the bottom basic mould releasably by means of an attachment arrangement, the bottom mould insert to the bottom basic mould forming a bottom mould assembly,
mounting the side mould assemblies and the bottom mould assembly to the direct injection manufacturing station, and
operating the direct injection manufacturing station.

A direct injection manufacturing station may typically be one of a number of manufacturing stations of an injection moulding equipment. An injection moulding equipment may also be referred to as a rotary table within the art. A direct injection manufacturing station may also within the art be referred to as a clamping unit. The number of clamping units/direct injection manufacturing stations may e.g. be 12, 18, 24, 30 or 36 in commercially available injection moulding equipment/rotary tables. It is however noted that injection moulding equipment may be configured differently than rotary tables in the context of the present invention. Where rotary tables are configured to have a number of the clamping units which are circulated from one or more input points, where a new footwear upper on a last is fitted to the rotary table at clamping unit with corresponding two side moulds and a bottom mould. The clamping unit mould parts (side moulds and bottom mould) gathers to each other and closes to the bottom of the footwear upper and forms a sole volume. The clamping unit is then circulated away from the injection location with the mould parts still confining the intended sole volume and the injected sole material is cured and thereby fixed to the footwear upper. Subsequently, the footwear upper, not having a sole attached, is removed from the rotary table and moved further on for subsequently processing. Non limiting examples of such a machinery may be a DESMA D522/24, DESMA D622/30 and DESMA D922/24.

It is however noted, that within the scope of the present invention, the use of side moulds and bottom moulds (including respective insert moulds) may also be applied for direct injection in direct injection moulding equipment other than a rotary table in relation how the gathered mould parts (clamping units) are moved to and from the injection station. The clamping stations including the associated lasted uppers may thus, instead of the rotary movement described above, be moved in straight lines from the injection station of an injection moulding equipment or the clamping stations including the associated lasted uppers may be carried away from the injection station and the injection moulding equipment e.g. on individual carriers, so that the curing of the sole onto the upper occurs at a time where the assembly of mutually fixed side moulds, bottom mould and the lasted upper are no longer directly attached to the machine performing the direct injection. An example of such alternative to a rotary table is disclosed and explained in DK patent application PA 2020 70841, “A MOULD DEVICE FOR DIRECT INJECTION MOULDING OF FOOTWEAR, A SYSTEM COMPRISING SUCH A MOULD DEVICE AND A DIRECT INJECTION MOULDING SYSTEM”.

In an embodiment of the invention, the footwear manufacturing station is operated by positioning a lasted upper of a footwear relative to the mounted side mould assemblies and the bottom mould assembly,
moving the side mould assemblies and the bottom mould assembly relative to the lasted upper, thereby forming a sole volume confined by the side mould assemblies, the bottom mould assembly and the bottom of the lasted upper,
injecting direct injection material, such as polyurethane, into the sole volume thereby moulding a sole onto the bottom of the lasted upper of a footwear, and
moving the side mould assemblies and the bottom mould assembly relative to the lasted upper and removing the lasted upper with the sole from the mould assembly.

According to an embodiment, the bottom mould insert may be releasably fixated to the bottom basic mould by slidingly engaging the bottom mould insert with the bottom basic mould.

Hereby, the bottom mould insert may be fixated in a convenient and relatively simple manner, e.g. by sliding the bottom mould insert in e.g. a horizontal direction along a plane of the bottom basic mould, until the two parts are in matching and/or predefined mutual positions. As the e.g. force applied during moulding, for example due to expansion of injected material, will be exerted in the predominantly vertical direction, it will be understood that the bottom mould insert may be held in place by such an arrangement and that the arrangement furthermore will prevent the bottom mould insert and parts hereof from moving away from the underlying bottom basic mould. It will be understood that the release of the fixation, e.g. removal of the bottom mould insert may be performed by e.g. a sliding the bottom mould insert in the opposite horizontal direction, thereby facilitating an effortless and simple removal in case of e.g. replacement due to wear, shift of mould design, e.g. sole design, etc.

According to an embodiment, the bottom mould insert may be releasably fixated to the bottom basic mould by slidingly engaging a tongue of the bottom mould insert with a groove of the bottom basic mould or alternatively by slidingly engaging a groove of the bottom mould insert with a tongue of the bottom basic mould.

Hereby, the bottom mould insert may be fixated in a convenient and relatively simple manner, e.g. by sliding the bottom mould insert in e.g. a horizontal direction along a plane of the bottom basic mould, until the tongue and groove are in matching and/or predefined mutual positions, whereby the fixation and in particular the vertical fixation may be provided by the tongue engaging with the groove, for example in case the tongue has sides that engage recesses in the walls of the groove or e.g. in case the tongue and groove have corresponding profiles with the width of the groove being smaller at the opening of the groove than at the bottom. Other options will be available. It will be understood that removal of bottom mould insert may be performed by e.g. a sliding the bottom mould insert in the opposite direction, thereby facilitating an effortless and simple removal in case of e.g. replacement due to wear, shift of mould design, e.g. sole design, etc. Furthermore, it is noted that as the e.g. force applied during moulding, for example due to expansion of injected material, will be exerted in the predominantly vertical direction, it will be understood that the bottom mould insert may be held in place by such a tongue/groove arrangement and that the arrangement furthermore will prevent the bottom mould insert and parts hereof from moving away from the underlying bottom basic mould.

According to an embodiment, the method according to any one of claims 28-31 may be applied by use of a direct injection footwear mould assembly according to any one of claims 1-25 and/or a direct-injection footwear bottom mould assembly according to claim 26 or 27.

### THE FIGURES

The invention will be explained in further detail below with reference to the figures of which

FIG. 1 shows a schematically illustrated basic direct injection mould, seen in a cross-sectional view, that may be used in connection with direct injection moulding of footwear according to the present disclosure,

FIG. 2 shows a cross-sectional schematic diagram of a footwear injection mould in accordance with the present disclosure,

FIGS. 3-6 show sectional schematic diagrams of a footwear injection mould from its open position to a closed position,

FIG. 7a illustrate a further embodiment of the direct injection mould inserts,

FIG. 7b shows an embodiment of a cross-sectional view of a footwear injection moulding system,

FIG. 7c is an enlarged view of a cut-out of FIG. 7b relating to the lip area of the direct injection mould inserts.

FIGS. 8a-d and 9a-9c illustrate different cross-sections in respective FIGS. 10A and 10B of mould assemblies within the scope of the invention,

FIG. 11A illustrates a longitudinal cross-section of the embodiments of FIGS. 8A and 8D,

FIG. 11B illustrate a longitudinal cross-section of the embodiment of 8B,

FIG. 12A illustrate a bottom mould assembly of the FIG. 8A embodiment,

FIG. 12B illustrate a bottom mould assembly of the FIG. 8B embodiment,

FIG. 13 illustrates the longitudinal cross sections of FIGS. 11A and 11B,

FIGS. 13a-c show in enhanced cross-sectional views schematic illustrations of various tongue and groove arrangements,

FIG. 14A-14F illustrates various principles provided within the scope of the invention and where

FIG. 15A-15G illustrate further various principles provided within the scope of the invention.

### DETAILED DESCRIPTION

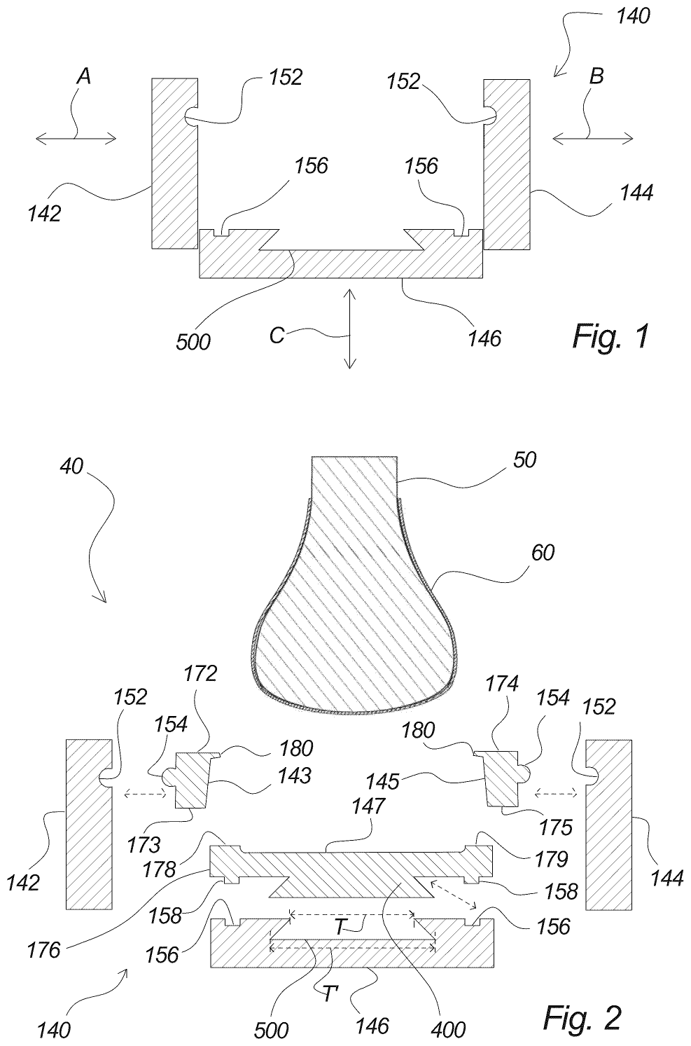

FIG. 1 shows a schematically illustrated basic direct injection mould 140, seen in a cross-sectional view, that may be used in connection with direct injection moulding of footwear according to the present disclosure. The basic direct injection mould 140 may comprise a first basic side mould 142, a second basic side mould 144 and a basic bottom mould 146. It is noted that more than these three basic parts may be used for forming a basic direct injection mould 140, e.g. two or more basic side moulds at one or both sides, etc.

The basic bottom mould furthermore comprises a groove 500 forming part of an attachment arrangement to be described in the following description.

Generally, it is noted that the basic parts are movable in relation to each other, e.g. by the first basic side mould 142 and the second basic side mould 144 being able to move in e.g. horizontal directions as indicated by the arrows A and B and by the basic bottom mould 146 being able to move in the e.g. vertical direction as indicated by the arrow C, whereby the basic direct injection mould 140 can be arranged to open and close around a last.

Furthermore, it is noted that the basic parts are arranged to be coupled with insert parts (not shown here), e.g. by means of basic side coupling elements 152 comprised by the first basic side mould 142 and the second basic side mould 144, for example on or in e.g. the inner surfaces of these. Correspondingly, the basic bottom mould 146 comprises basic bottom coupling elements 156, for example on or in e.g. the inner surface of the basic bottom mould 146.

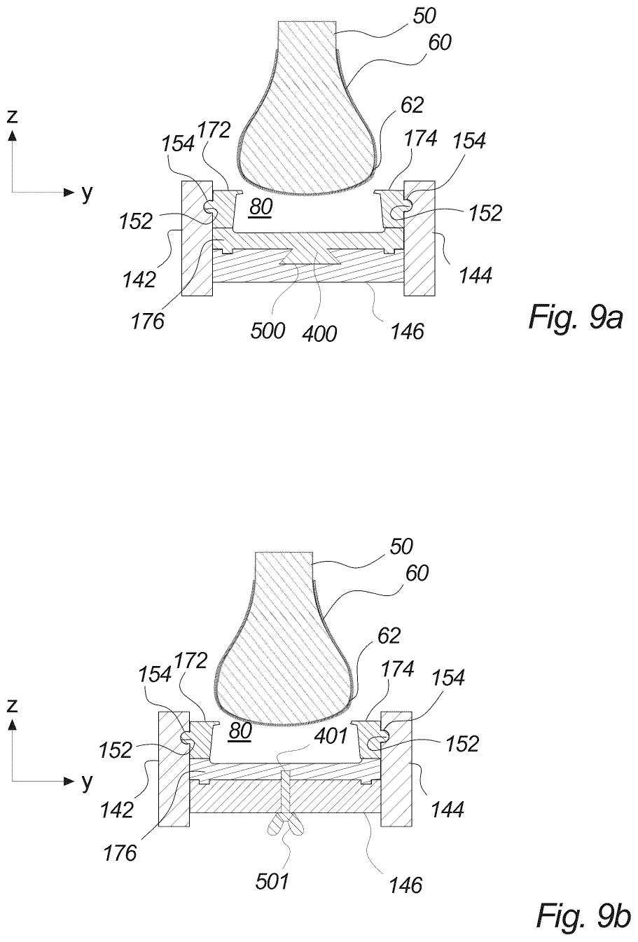

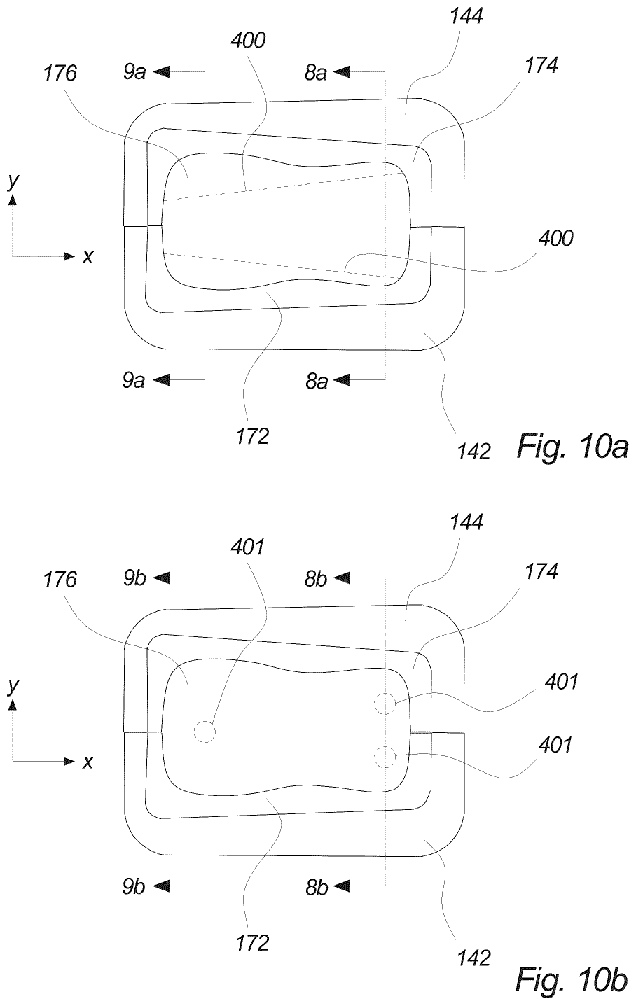

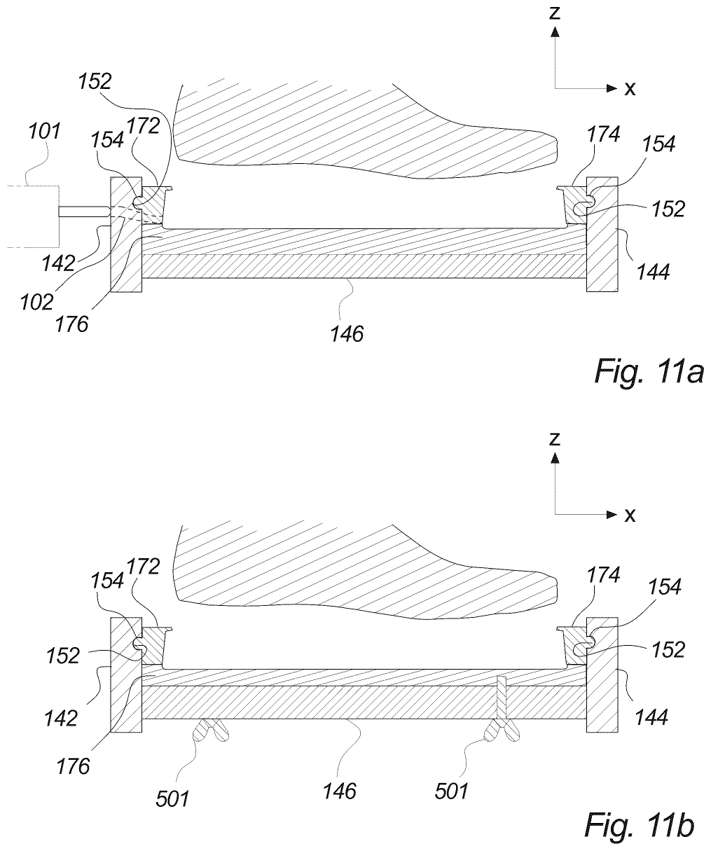

Even further, it is noted that the basic direct injection mould 140 may be configured to be attached to direct injection manufacturing stations of injection moulding equipment (cf. 101; FIG. 11a).

A direct injection manufacturing station may typically be one of a number of manufacturing stations of an injection moulding equipment. An injection moulding equipment may also be referred to as a rotary table within the art. A direct injection manufacturing station may also within the art be referred to as a clamping unit. The number of clamping units/direct injection manufacturing stations may e.g. be 12, 18, 24, 30 or 36 in commercially available injection moulding equipment/rotary tables. It is however noted that injection moulding equipment may be configured differently than rotary tables in the context of the present invention. Where rotary tables are configured to have a number of the clamping units which are circulated from one or more input points, where a new footwear upper on a last is fitted to the rotary table at clamping unit with corresponding two side moulds and a bottom mould. The clamping unit mould parts (side moulds and bottom mould) gathers to each other and closes to the bottom of the footwear upper and forms a sole volume, e.g. an injection volume. The clamping unit is then circulated away from the injection location with the mould parts still confining the intended sole volume and the injected sole material is cured and thereby fixed to the footwear upper. Subsequently, the footwear upper, now having a sole attached, is removed from the rotary table and moved further on for subsequently processing. Non limiting examples of such a machinery may be a DESMA D522/24, DESMA D622/30 and DESMA D922/24.

It is however noted, that within the scope of the present invention, the use of side moulds and bottom moulds (including respective insert moulds) may also be applied for direct injection in direct injection moulding equipment other than a rotary table in relation how the gathered mould parts (clamping units) are moved to and from the injection station. The clamping stations including the associated lasted uppers may thus, instead of the rotary movement described above, be moved in straight lines from the injection station of an injection moulding equipment or the clamping stations including the associated lasted uppers may be carried away from the injection station and the injection moulding equipment e.g. on individual carriers, so that the curing of the sole onto the upper occurs at a time where the assembly of mutually fixed side moulds, bottom mould and the lasted upper are no longer directly attached to the machine performing the direct injection. An example of such alternative to a rotary table is disclosed and explained in DK patent application PA 2020 70841, “A MOULD DEVICE FOR DIRECT INJECTION MOULDING OF FOOTWEAR, A SYSTEM COMPRISING SUCH A MOULD DEVICE AND A DIRECT INJECTION MOULDING SYSTEM”.

FIG. 2 shows a cross-sectional view of a footwear injection mould 40 in accordance with the present disclosure, where the cross sectional plane may be a vertical plane that may be seen as being perpendicular to the longitudinal axis of the footwear injection mould. The footwear injection mould comprises a basic direct injection mould 140 as described above and insert parts, examples of which will be described in the following.

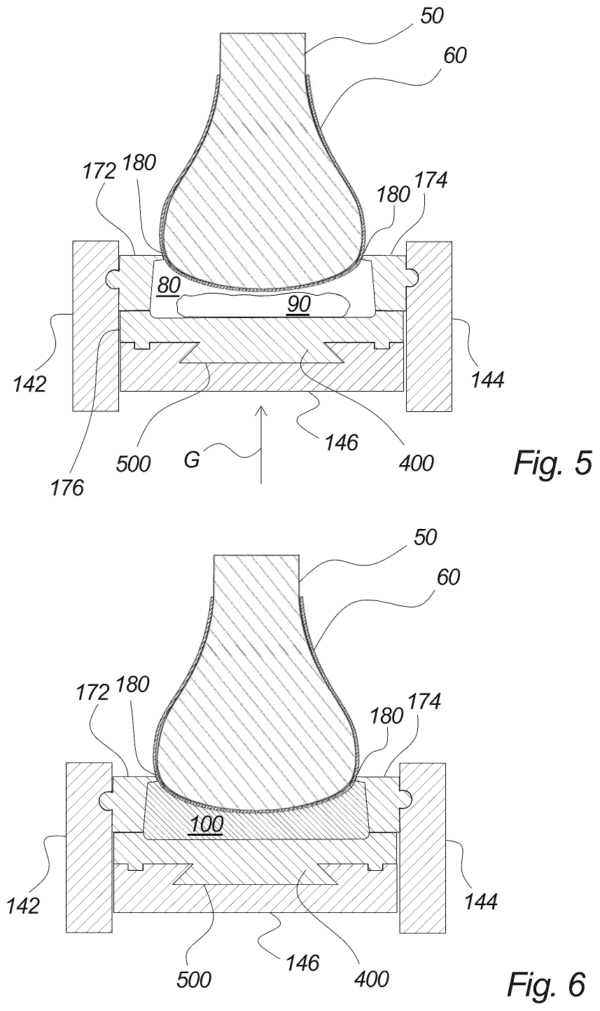

Thus, the footwear injection mould 40 comprises a basic direct injection mould 140 having a first basic side mould 142, a second basic side mould 144 and a basic bottom mould 146. The footwear injection mould 40 in FIG. 2 is in an open state, where the first basic side mould 142, the second basic side mould 144 and the basic bottom mould 146 are spaced from each other, allowing access to the inner space from one or more positions, e.g. in order to allow insert parts to be mounted. The first basic side mould 142, the second basic side mould 144 and the basic bottom mould 146 are provided with attachment parts (not shown) that allow the basic direct injection moulds 142, 144, 146 to be attached to an injection moulding equipment (cf. FIG. 11a, illustrating injection moulding equipment 101, by means of which injection material may be injected via a schematically shown injection channel 102), and where the attachment to the injection moulding equipment may be adapted to transfer heat from the injection moulding equipment to the basic direct injection moulds 142, 144, 146 so that the footwear injection mould can be warmed up to a predefined temperature to optimize the injection moulding of the footwear part in the mould cavity 80 (e.g. FIG. 5).

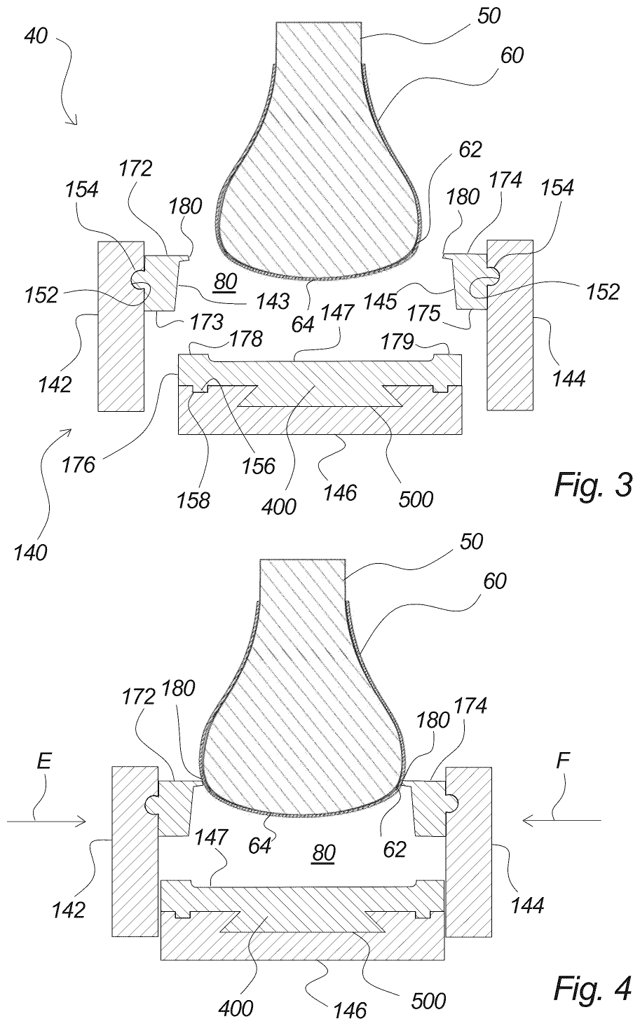

The first basic side mould 142, the second basic side mould 144 and the basic bottom mould 146 may be provided with a first side insert 172, a second side insert 174 and a bottom insert 176, respectively, where the first side insert 172, the second side insert 174 and the bottom insert 176 may be coupled to the first basic side mould 142, the second basic side mould 144 and the basic bottom mould 146, respectively. The first basic side mould 142 and the second basic side mould 144 may be provided with basic side coupling elements 152 that are adapted to mate with insert side coupling elements 154 that allow the first side insert 172 and the second side insert 174 to be coupled to the first basic side mould 142 and the second basic side mould 144, respectively. The coupling elements 152, 154 may be adapted to hold the first side insert 172 and the second side insert 174 relative to the first basic side mould 142 and the second basic side mould 144, respectively, during the injection moulding process. In an analogous manner, the basic bottom mould 146 may be provided with basic bottom coupling elements 156 that that are adapted to mate with bottom insert coupling elements 158 that allow the bottom insert 176 to be coupled to the basic bottom mould 146. The coupling elements 156, 158 may be adapted to hold the bottom insert 176 relative to the basic bottom mould 146 during the injection moulding process. Thus, it may be ensured that the first side insert 172, the second side insert 174 and the bottom insert 176 are held in position while the footwear injection mould 40 is moved from its open position, as shown in FIG. 3 towards its closed position, shown in FIG. 5 and during the injection moulding process, as shown in FIG. 6.

The bottom mould insert 176 is furthermore configured with a part of the attachment arrangement mentioned in FIG. 1, as the mould insert 176 is configured with a tongue 400.

As further illustrated in FIG. 2, the first side insert 172, the second side insert 174 and the bottom insert 176 may be coupled to the first basic side mould 142, the second basic side mould 144 and the basic bottom mould 146, respectively, when the basic direct injection mould 140 is in an open state, e.g. by engaging the respective coupling elements 152, 154, 156, 158 as indicated with the dash lined arrows in FIG. 2. These coupling elements may be designed in various manners, e.g. as snap-locking means, self-locking means, press couplings, mating couplings, etc. It is noted that for the sake of clarity, the first basic side mould 142, the second basic side mould 144 and the basic bottom mould 146 are shown in FIG. 2 in positions removed from each other, whereby furthermore the coupling with the insert parts, e.g. 172, 174 and 176 may be clearly observed.

The groove 500 of the bottom basic mould 146 and the tongue 400 of the bottom mould insert 176 are mutually fitting each other and the tongue of the bottom mould insert mould may be slided into the groove of the bottom basic mould thereby fixating the bottom mould insert to the bottom basic mould in the vertical direction. The illustrated arrow does not show the actual direction of insertion, but it is merely meant to illustrate that the fixation of the bottom mould insert 176 to the bottom basic mould 146 must be performed prior to operation of the mould assembly 140 in DIP equipment.

In FIG. 2 it is illustrated that the upper part of the groove 500, i.e. at the opening of the groove (and correspondingly the upper part of the tongue, i.e. the root, although not illustrated in FIG. 2) has a width T and that the lower part of the groove 500, i.e. the bottom of the groove (and correspondingly the lower part of the tongue 400, i.e. the free end of the tongue) has a width T′. The width T′ is larger than the width T by a suitable amount, when the tongue/groove arrangement is configured to fixate the bottom mould insert in the vertical direction.

Examples of other ways of securing the bottom mould insert to the bottom basic mould are disclosed in the following description.

It is noted that the basic bottom coupling elements 156 and the bottom insert coupling elements 158 need not be provided when a tongue 400 and groove 500 attachments is utilized as the latter may provide the necessary coupling and furthermore provide the fixation in the vertical direction.

FIG. 3 shows a cross-sectional view of a footwear injection mould 40 corresponding to FIG. 2, wherein the first side insert 172, the second side insert 174 and the bottom insert 176 have been fixated to the first basic side mould 142, the second basic side mould 144 and the basic bottom mould 146, respectively.

The groove 500 of the bottom basic mould 146 and the tongue 400 of the bottom mould insert 176 are mutually fitting each other and the tongue of the bottom mould insert mould has been inserted into the groove of the bottom basic mould thereby fixating the bottom mould insert to the bottom basic mould in the vertical direction, here along the entire length of the bottom mould.

Moreover, the side mould insert 172 and 174 has been releasably fixated to the first basic side mould 142 and the second basic side mould 144 by means of an attachment arrangement (not shown). The side mould insert 172 and 174 may thus be fixed to the first basic side mould 142 and the second basic side mould 144, respectively, by means of screws, snaplocks, nut and bolts or whatever suitable arrangement.

Further, the footwear injection mould 40 has been arranged in an open state with a last 50, which carries a footwear upper 60, placed in a position near the opening of the footwear injection mould 40.

The first side insert 172, the second side insert 174 and the bottom insert 176 may be adapted to provide a mould cavity 80, by providing a first side insert surface 143, a second side insert surface 145 and a bottom insert surface 147 providing an outer surface of the element to be moulded inside the mould cavity 80. The upper part of the mould cavity 80 may be delimited by the footwear upper 60, which may be mounted on a last 50, where the last fixes the upper 60 relative to the mould cavity 80. Furthermore, the first side insert 172 and the second side insert 174 are provided with a lip 180, where the lip has a form and shape that is adapted to follow an outer surface 62 of the upper 60. When the lip 180 is pushed into contact with the outer surface 62 of the upper 60, as e.g. seen in FIG. 4 the lip may close off the mould cavity in conjunction with the bottom part 64 of the upper 60, and assist in preventing that injection moulding material which is introduced into the mould cavity 80 can exit the mould cavity 80 via the upper opening of the cavity 80.

The first side insert 172 and the second side insert 174 may be provided with a first 173 and a second contact surface 175 positioned on a bottom part of the first side insert 172 and the second side insert 174, respectively, which may be adapted to abut a first 178 and a second 179 upper contact surface of the bottom insert surface 176. The contact surfaces may be adapted to close off the mould cavity 80 between the first side insert 172, the second side insert 174 and the bottom insert 176. The contact surface may extend from a front end (toe end) of the first side insert 172, the second side insert 174 and the bottom insert towards its back end (heel end).

Furthermore, the first side insert 172 and the second side insert 174 may have third and/or a fourth contact surface (not shown) between the moulds, where the contact surfaces may be positioned in an area where the first side insert 172 and the second side insert 174 divide the sides of the mould cavity between them. FIG. 3 shows that the last 50 has been introduced into the moulding cavity, allowing the bottom part of the footwear upper 60 to be exposed to the upper part of the mould cavity 80. The last 50 may be moveable in a vertical direction in and out of the mould cavity 80, so that when the footwear part has been moulded to the upper, the last 50, the upper 60 and the footwear part may be maneuvered away from the mould cavity for removal, and the next last and upper may be introduced into the mould cavity.

FIG. 4 shows an intermediate state of the footwear injection mould, where the first basic side mould 142, the second basic side mould 144, the first side insert 172 and the second side insert 174 have been maneuvered inwards in the directions E, F towards the upper 60, where the lip 180 is moved into contact with the upper 60, and the first side insert 172 and the second side insert 174 come into contact with each other at their toe and heel end (not shown) to close off the upper part of the mould cavity 80. The lip 180 and the contact surfaces are forced into contact so that the flow of the injection material cannot pass out of the mould cavity via the contact surfaces and the lip 180.

Prior to or during this movement, the injection material 90, may be introduced into the mould cavity, e.g. by introducing it to the upper surface 147 of the bottom insert 176 prior to the closing of the footwear injection mould 40, where the mould 40 may be closed allowing the injected material to expand to fill the mould cavity 80 and to bond to the lower/bottom part 64 of the upper 60.

FIG. 5 shows where the basic bottom mould 146 and the bottom insert 176 have been moved upwards in a vertical direction G, where the bottom insert 176 abuts the first side insert 172 and the second side insert 174, thus closing the mould cavity 80. When the footwear injection mould 40 is closed, the mould cavity 80 is closed to the surrounding environment, ensuring that the injected material 90 takes the shape of the mould cavity 80.

It is noted that a sole part, e.g. a premanufactured outer sole (not shown) may be inserted in the mould cavity 80 prior to closing and positioned on the e.g. upper surface 147 of the bottom insert 176 prior to injection of material 90, whereby the outer sole will be bonded to the expanded and cured injected material 90 and form the outsole of the footwear sole 100. Other premanufactured parts may be included in the footwear instead or in addition in a similar manner, thereby being bonded to the footwear construction by the expanded and cured injected material 90.

FIG. 6 shows where the injected material 90 has expanded to fill out the entire volume of the mould cavity 80, where the injected material 90 comes into contact with the inner surfaces of the first side insert 172, the second side insert 174 and the bottom insert 176, causing the outer surface of the injected material 90 to take the shape of the mould cavity and the inner surfaces of the first side insert 172, the second side insert 174 and the bottom insert 176, to form a footwear sole 100.

When the injected material 90 has cured, the first 142 and second basic side mould 144 together with the first side insert 172 and the second side insert 174, respectively, may be moved in a horizontal movement opposite to the direction E, F shown in FIG. 4, and the basic bottom mould 146 together with the bottom insert 176 may be moved in the opposite direction to the direction G shown in FIG. 5, thereby opening the footwear injection mould. The movement of the first basic side mould 142, the second basic side mould 144 and the basic bottom mould 146 allows the first side insert 172, the second side insert 174 and the bottom insert 176 to be removed from the injected material 90 and the last 50, the upper 60 and the sole 100 may be removed from the mould 40.

If the injection moulding equipment is supposed to be utilized for a different type of shoe or a different size of shoe, the first side insert 172, the second side insert 174 and the bottom insert 176 may be de-coupled from the basic direct injection mould 140, e.g. from the first 142 and second basic side mould 144 and from the basic bottom mould 146, and replaced with another set of first side insert 172, second side insert 174 and bottom insert 176, that define an alternative mould cavity, as well as exchanging the last and the upper to close off the upper part of the mould cavity, where the additional set of first side insert, second side insert and bottom insert may be coupled to the basic direct injection mould 140, e.g. to the first 142 and second basic side mould 144 and to the basic bottom mould 146, respectively. Thus, the basic direct injection mould 140 may be utilized for a plurality (more than one) of inserts, e.g. a first side insert, a second side insert and a bottom insert, and the injection moulding equipment may be quickly made ready for the injection of a different type of article of footwear.

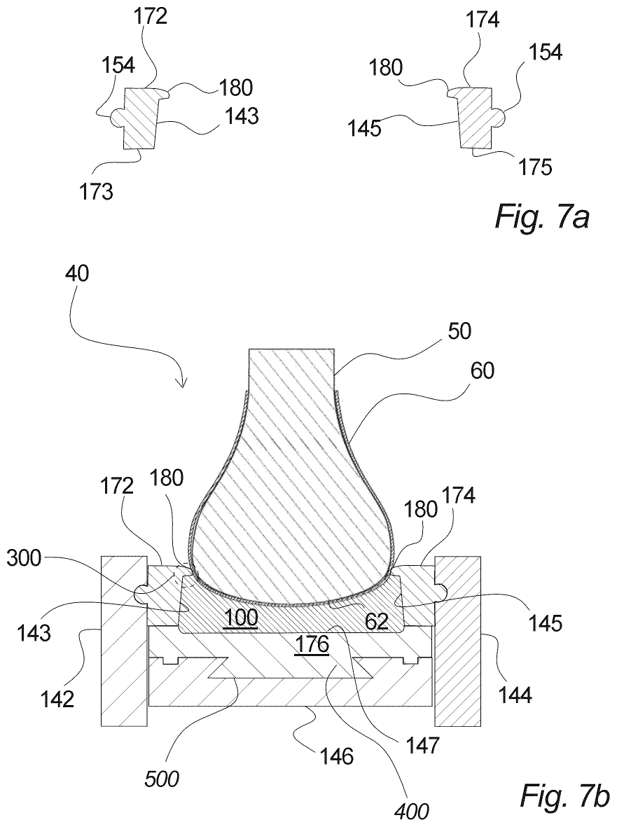

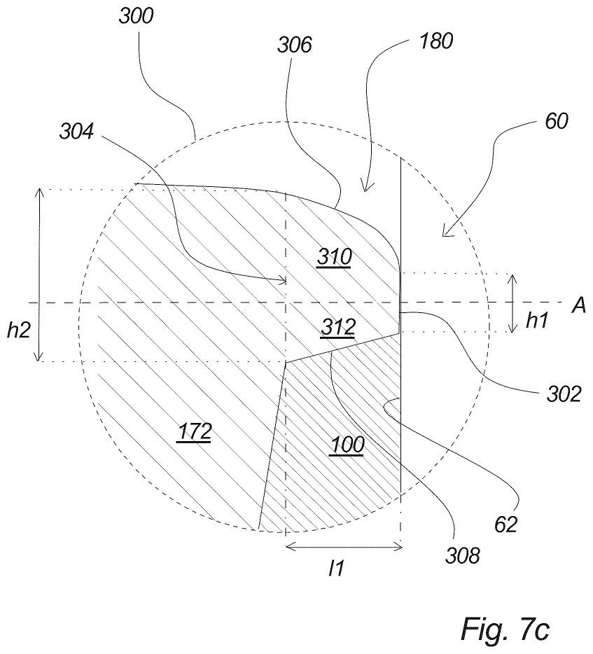

FIGS. 7A-C illustrate a further embodiment of the direct injection mould inserts and in particular the first side insert 172 and the second side insert 174. Thus, FIG. 7a shows an embodiment of a cross-sectional view of a pair of a first side insert 172 and a second side insert 174, corresponding to the examples as illustrated in e.g. FIGS. 2-6. However, the insert lip 180 of the side inserts as illustrated in FIGS. 7a-7c is configured in a particular manner as it will be explained in the following.

FIG. 7b corresponds to FIG. 6 and thus shows an embodiment of a cross-sectional view of a footwear injection moulding system 40, where a footwear part is moulded and where the side inserts as illustrated in FIG. 7a are applied. Thus, it is shown that injected material has expanded to fill the mould cavity to form a footwear sole 100 as it has been explained in connection with e.g. FIGS. 2-6.

FIG. 7b shows that the injected material has expanded to fill out the entire volume of the injection chamber and thus has come into contact with the inner surfaces 143, 145, 147 of the first side insert 172, the second side insert 174 and the bottom insert 176, respectively, and the outer surface 62 of the footwear upper 60, thereby causing the injected material to take the corresponding shape to form a footwear sole 100.

When the injected material has cured, the first 142 and second basic side mould 144 together with the first side insert 172 and the second side insert 174, respectively, may be moved in an e.g. horizontal movement, and the basic bottom mould 146 together with the bottom insert 176 may be moved e.g. downwards, thereby opening the footwear injection mould, whereby the last 50, the upper 60 and the sole 100 may be removed from the mould 40.

In FIG. 7b, the lip 180 is pushed into contact with the outer surface 62 of the footwear upper part 60. Thereby, the lip 180 closes off (seals off) the injection chamber together with the bottom part of the footwear upper part 60, and assists in preventing injected material, which is introduced into the injection chamber, from escaping the injection chamber via the upper part of the injection chamber. The lip 180 may have a shape that is adapted to follow the outer surface 62 of the footwear upper 60.

The features of the first side insert 172 and the second side insert 174 and in particular the lip 180 will be explained in further detail in the following with reference to FIG. 7c, which is an enlarged view of the cut-out 300 shown in FIG. 7b, where the circular cut-out 300 is relating to the lip area of the first side insert 172. It will be understood, though, that what is explained in the following similarly applies to the second side insert 174, its lip 180, etc. as well.

In FIG. 7c, the cut-out 300 shows the lip 180 contacting the outer surface 62 of the footwear upper 60, wherein the lip 180 may have a shape that is adapted to follow the outer surface 62 of the footwear upper 60. The lip 180 may be in the form of a ridge.

The shape of the lip 180 and of said outer surface 62 are shown to be flat and to extend in a plane, e.g. a vertical plane. Obviously, the lip 180 and the outer surface 62 may have various other shapes, such as rough, bend, curvilinear.

The lip 180 may comprise an upper contacting surface 302 for contacting the outer surface 62 of a footwear upper 60, a connecting end 304 connected to the first side insert 172, an upper surface 306 faced away from the injection chamber and a lower surface 308 faced towards the injection chamber as shown in FIG. 7c.

The lip 180 may have a height h2 at the connecting end 304 of the lip 180 that is larger than the height h1 at the upper contacting surface 302 of the lip 180, relative to a normal A of the upper contacting surface 302. The normal A of the upper contacting surface 302 is configured to intersect a centre point of the upper contacting surface 302 seen in the height direction as illustrated in FIG. 7c. A lip plane is defined by the normal A of the upper contacting surface 302 along a width of the lip 180, said lip plane configured to define a boundary between an upper half 310 and a lower half 312 of the lip 180, the upper half 310 arranged between the lip plane and the upper surface 306 and the lower half 312 arranged between the lip plane and the lower surface 308.

The lip 180 has a length l1 (as shown in FIG. 7c) defined by the distance from the upper contacting surface 302 to the connecting end 304 along the normal A of the upper contacting surface 302.

In one example, the height h1 may be in the region between 2 to 6 mm, where the height h1 may more specifically be between 3 and 5 mm, or even more specifically around 4 mm. The height h1 of the upper contacting surface 302 has been shown as being above 2 mm, as a lower thickness may cause the material to bend, deform or warp during injection. This may especially be in a situation where the mould insert is 3D printed from e.g. a polymeric material.

In comparison, traditional moulds, made out of aluminum or other metal substances may have an upper contacting surface height h1 that is around 1.5 mm.

In one example, the height h2 may be between 6 and 15 mm, where the height h2 may more specifically be between 7 and 12 mm, where the height may more specifically be between 5-8 and 10 mm. The increased height h2 provides support to the lip especially when the material is 3D printed from e.g. a polymeric material. In comparison, traditional moulds made out of aluminium or other metal substances may have a height h2 that is close to 2-3 mm.

In one embodiment the size ratio between the height h1 and h2 may be around 1:2, where h2 may be twice the height of h1. In one embodiment the size ratio may be around 1:1.5, where the height h2 is 50% larger than h1.

In one exemplary embodiment the length of the lip l1 may have a size that is at least larger than the height h2, i.e. that the length ratio between the length of the lip vs. the height h2 is at least 1:1. In another embodiment the length of the lip may have a size that is smaller than the height h2, i.e. l1<h2. Thus, the height h2 provides support for the length of the lip, where the height h2 of the lip may have to be increased when the length l1 is increased.

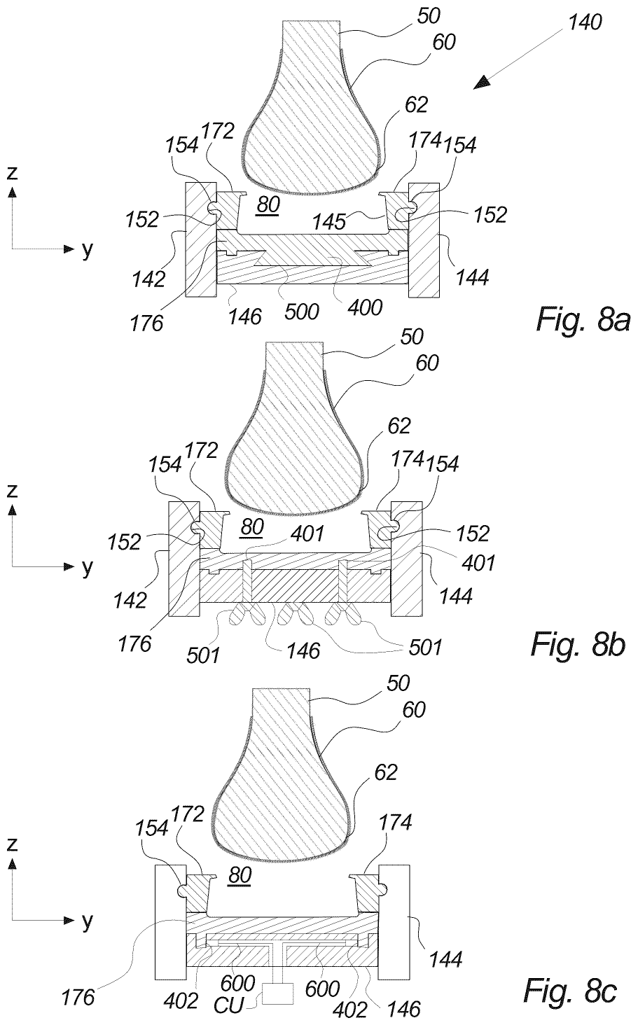

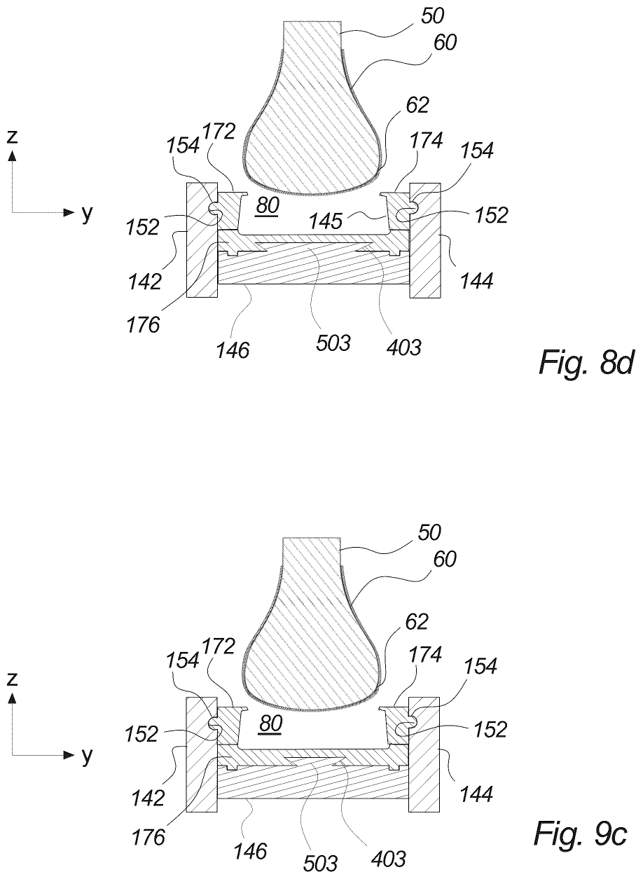

FIGS. 8a-d and 9a-9c illustrate different cross-sections in respective of FIGS. 10A and 10B of mould assemblies within the scope of the invention.

FIG. 8a corresponds to FIG. 5 with respect to components of the mould assembly, although sole injection has been omitted as the main of this and the following figures are to explain examples of variations within the scope of the invention.

In the present context the cross-sections of FIG. 8a and FIG. 9a are shown as illustrated in FIG. 10a. FIG. 10a illustrates the embodiment from above, in the the x-y direction.

FIGS. 8a, 9a and 10a thus illustrate a dove tail-line tongue 400 form which is preferably 3D printed into the bottom mould insert (i.e. forming part of the bottom mould insert (176)). The tongue 400 is narrowing towards one end of the mould insert and fits into a corresponding groove 500 formed in the bottom basic mould.

This particular configuration is advantageous as the bottom mould insert may be easily inserted into the bottom basic mould and is restricted for movement in the vertical direction and also one of the x-directions. Furthermore the mould inserts, when printed e.g. in polymer or other material being highly sensitive to temperature variations (expand/shrink), will tend to fix to the form when temperature rises during use of the bottom mould assembly in the process of a direct injection process of soles onto footwear uppers, as the mould insert will expand and thereby be fixed to the bottom mould insert.

Preferably, the mould inserts 172, 174 are also releasably fixated to the respective side basic moulds 142, 144 by an attachment arrangement (not shown).

FIGS. 8b, 9b and 10b illustrate a different configuration of an attachment arrangement for releasably fixating a bottom mould insert 176 to a bottom basic mould 146. In this embodiment three butterfly nuts 501 are attached to a bolt projecting into the bottom mould insert 176 and fixations points 401 of the bottom mould insert, two butterfly nuts 501 at one end of the bottom mould assembly and one butterfly nut at the other end.

FIG. 8c illustrates a further embodiment within the scope of the invention where a control unit CU is configured to activate pins 402 to engage or disengage respective engagement areas 403 (holes) of a bottom mould insert 176 via an activation medium 600 such as e.g. pneumatics, hydraulics, electromagnetic activation etc., The attachment arrangement may comprise any suitable number of such pins and the pins may be configured differently as the illustrated as long as the bottom mould insert may be sufficiently fixated to the bottom basic mould during operation of the associated direction injection manufacturing equipment.

FIGS. 8d and 9c illustrates further embodiments within the scope of the invention essentially corresponding to the embodiments that have been described above with reference to FIGS. 8a and 9a, but wherein the dove-tail line tongue 400 (here also referred to as an upright tongue 503) has been formed into the basic bottom mould 146 and wherein the corresponding groove 500 has been formed in the bottom mould insert 176 as an engagement area 403, e.g. by 3D printing of the bottom mould insert. As in connection with FIGS. 8a and 91, the tongue 400 is narrowing towards one end of the mould insert and fits into the corresponding groove 500 formed in the bottom mould insert, e.g. with the tongue 400 and groove being broader at the cross-section position as shown in FIG. 8d and narrowing or tapering down towards the position as shown in FIG. 9c.

FIG. 11A illustrates a longitudinal cross-section of the embodiments of FIGS. 8A and 8D and FIG. 11B illustrates a longitudinal cross-section of the embodiment of 8B.

As mentioned above, FIG. 11a furthermore illustrates that injection moulding equipment 101 may be arranged e.g. at the heel end of the mould, by means of which injection material may be injected via a schematically shown injection channel 102 into a moulding cavity.

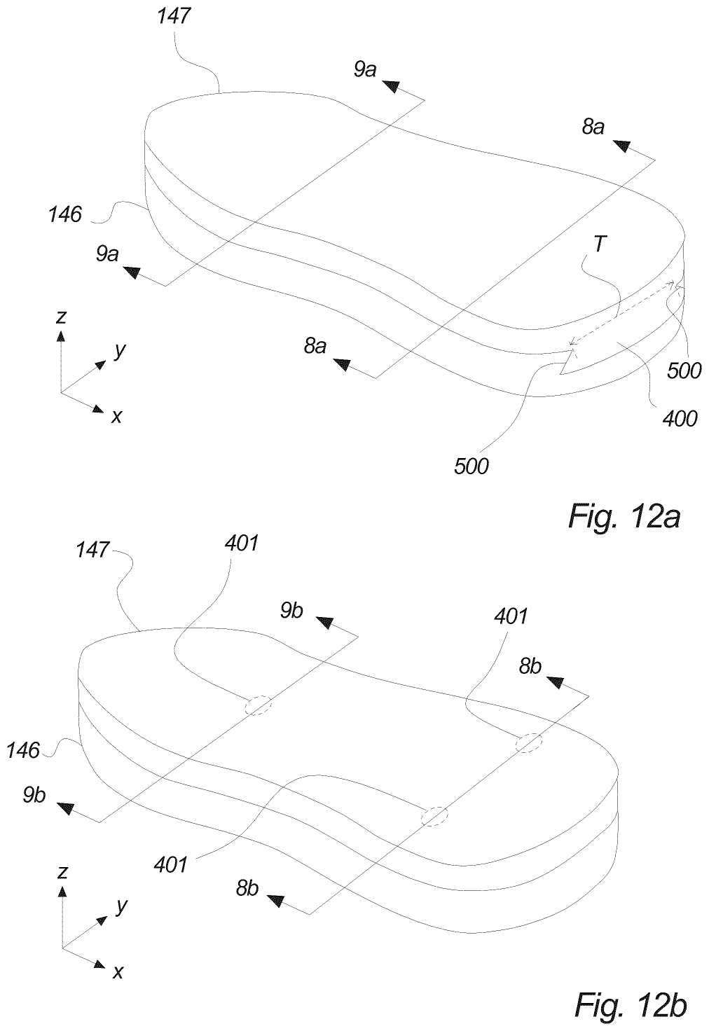

FIG. 12A illustrates a bottom mould assembly of the FIG. 8A embodiment and FIG. 12B illustrates a bottom mould assembly of the FIG. 8B embodiment. Thus, in FIG. 12A the cross-sectional view 8a-8a as shown in FIG. 8a is indicated as well as the cross-sectional view 9a-9a as shown in FIG. 9a. Further, in FIG. 12B the cross-sectional view 8b-8b as shown in FIG. 8b is indicated as well as the cross-sectional view 9b-9b as shown in FIG. 9b. Even further, in FIG. 12A the end of the tongue 400 in the bottom mould insert and the corresponding end of the groove 500 in the basic bottom mould 146 are illustrated with the width T of the tongue 400 at the root, corresponding to the width of the groove 500 at its opening is indicated.

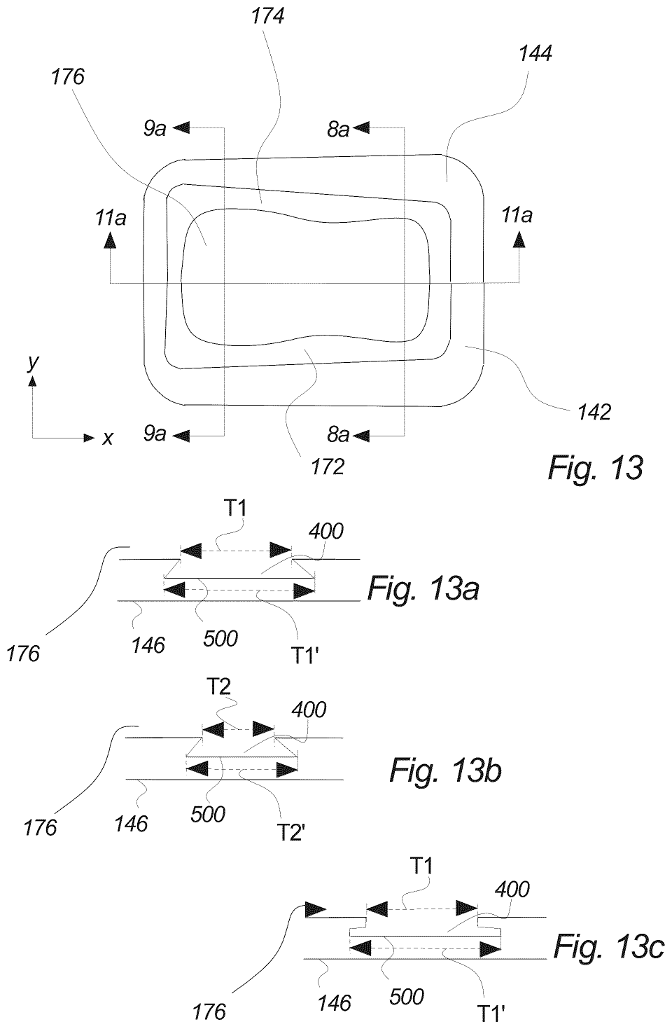

FIG. 13 shows, seen from above, a mould with a first 142 and a second basic side mould 144, each being coupled to the respective first side insert 172 and the second side insert 174, and where furthermore a bottom mould insert 176 can be seen. Here, the longitudinal cross section of FIG. 11A is indicated as well as the cross-sectional views 8a-8a and 9a-9a, cf, FIGS. 8A and 8B, respectively.

FIGS. 13a-13c show in schematic manners enhanced views of cross-sectional views of the tongue and groove arrangements as has been shown in FIGS. 8a and 9a. FIG. 13a corresponds to FIG. 8a and shows part of the basic bottom mould 146 with the groove 500 and part of the bottom mould insert 176 with the tongue 400. As indicated, the tongue 400 has a width T1 at the root of the tongue (at the upper part in this configuration) and the groove 500 has a corresponding width here. In order to effect the fixation of the bottom mould insert 176 in the vertical direction, the tongue and the groove tapers outwards in the downward direction, whereby the tongue and the groove at the lower level, e.g. at the free end of the tongue and at the bottom of the groove has a width T1′ that is larger than T1 in order to provide the fixation in the vertical direction.

A similar scenario is shown in FIG. 13b, which corresponds to FIG. 9a, and where it is shown that the tongue 400 has a width T2 at the root of the tongue (at the upper part in this configuration) and the groove 500 has a corresponding width the at its bottom. The width T2 is smaller than T1, meaning that the tongue and the groove 500 narrows down when nearing the position of FIG. 13b, whereby it will be seen that the tongue 400 (and the bottom mould insert 176) will have to be inserted from the position in FIG. 13a until it is positioned by the taper of the tongue and groove. It is noted that the tongue 400 and the groove 500 at the lower level, e.g. at the free end of the tongue and at the bottom of the groove has a width T2′ that is larger than T2 in order to provide the fixation in the vertical direction. As FIGS. 13a and 13b relates to the same set-up, the amount of enlargement of T2 to T2′ is essentially the same as the amount of enlargement from T1 to T1′.

FIG. 13c illustrates a further embodiment of a tongue and groove arrangement for effecting a fixation of a bottom mould insert 176 in the vertical direction to a basic bottom mould 146. Here, it is illustrated that the walls of the tongue 400 and groove 500 may not necessarily taper linearly outwards, but may be stepped in form as shown in FIG. 13c, e.g. as long as it is effected that the width of the tongue 400 at its free end is larger than the opening of the groove 500. Other forms and variations than have been shown in FIG. 13a-13c may be used as well.

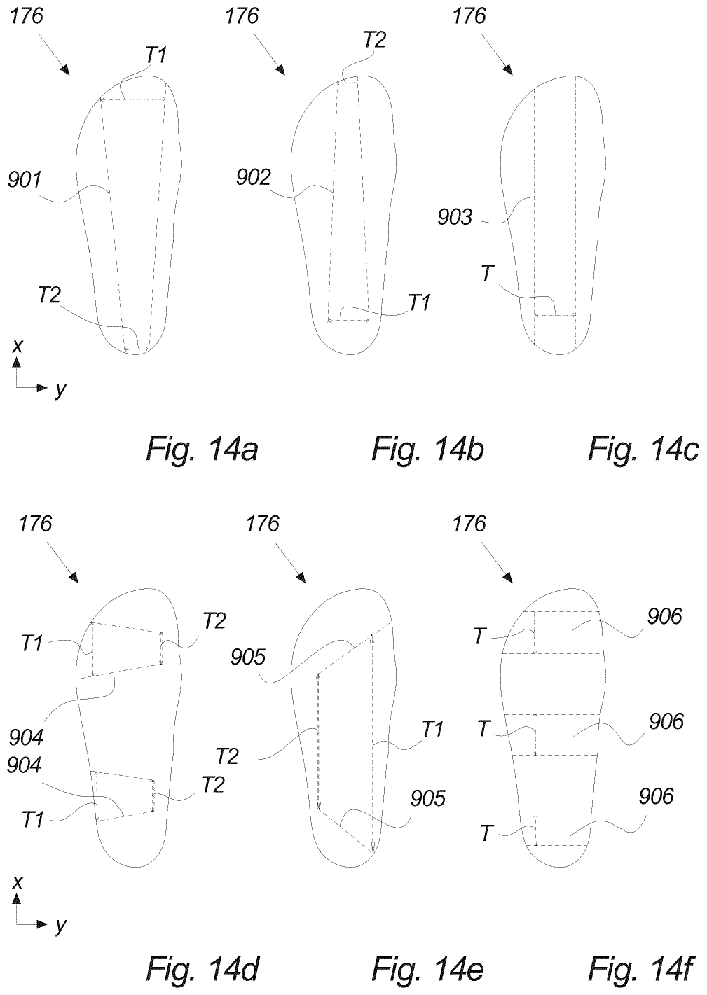

Even further, FIG. 14A-14F illustrate various principles provided within the scope of the invention.

The various embodiments are shown by illustrations of different configurations of bottom mould inserts 176, seen from above, e.g. with configurations of tongues indicated with dash lines. The configurations of the illustrated bottom mould inserts 176 should of course match the bottom basic mould 146 so as to facilitate the intended reliably fixation of bottom mould insert 176 to respective (not shown) bottom basic moulds. It is however noted that the bottom mould attachment arrangement 901 of FIG. 14a in principle corresponds to the embodiment of FIGS. 8a, 9a and 10a as explained above with a tongue form tapering from the width T1 to the width T2.

FIG. 14B illustrates a variant of FIG. 14A, where the tongue of a bottom mould attachment arrangement 902 has a different layout.

FIG. 14C illustrates a variant of FIG. 14A, where the tongue of a bottom mould attachment arrangement 903 has not been inclined and may thereby fit into a corresponding bottom basic mould (not shown). In this embodiment, a groove om the corresponding bottom basic mould forms a guide rail to the bottom mould insert.

FIGS. 14D, 14E and 14F illustrates three variants of bottom mould insert tongues 904, 905, 906, where the tongues of the bottom mould inserts 904, 905, 906 may be inserted into corresponding grooves of the bottom moulds (not shown) from the side. It is noted that FIGS. 14D and 14E show tongues that taper from T1 to T2, whereas FIG. 14F shows a configuration with three tongues that essentially are parallel and have parallel sides as well as indicated in the figure.

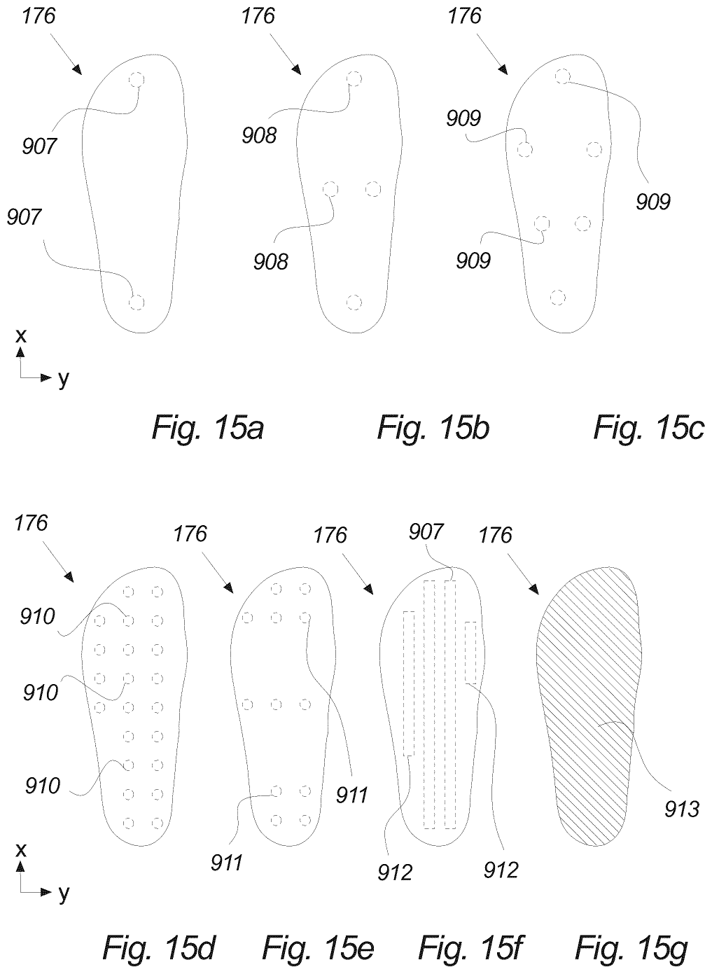

FIG. 15A-15G illustrate further various principles provided within the scope of the invention and where FIG. 15A-15E illustrate five different alternatives within the scope of the invention, where the bottom mould inserts 15A-15E during operation are releasably fixated to the respective bottom basic moulds (not shown) by means of attachment arrangements 907-911 and where the attachment is obtained by vacuum. The vacuum should be very strong and be maintained during operation of the mould assembly and the vacuum may be shut off, when the bottom mould inserts are to be released. It is noted that the vacuum forming equipment (not shown) are associated with the bottom basic mould (not shown) and the illustrated attachment arrangements 907-911 of the bottom mould inserts refers to areas of the bottom mould inserts where suction is applied to. In order to make this arrangement work, the surface to be subjected to suction must facilitate very low leaking.

FIGS. 15F and 15G illustrates an embodiment where attachment arrangements 912 and 913 of the bottom mould inserts are formed with a metal material, which when subjected to magnetic forces will provide a secure and reliable attachment of the bottom mould insert onto the respect bottom basic mould (not shown)

In the above description, various embodiments of the invention have been described with reference to the drawings, but it is apparent for a person skilled within the art that the invention can be carried out in an infinite number of ways, using e.g. the examples disclosed in the description in various combinations, and within a wide range of variations within the scope of the appended claims.

### LIST OF REFERENCE NUMBERS

40 Footwear injection mould
50 Last
60 Footwear upper
62 Outer surface
64 Bottom part
80 Mould cavity
90 Injected material
100 Footwear sole
101 Injection moulding equipment
102 Injection channel
140 Basic direct injection mould
142 First basic side mould
143 First side insert surface
144 Second basic side mould
145 Second side insert surface
146 Basic bottom mould
147 Bottom insert surface
152 Basic side coupling element
154 Insert side coupling element
156 Basic bottom coupling element
158 Bottom insert coupling element
172 First side insert
173 First contact surface
174 Second side insert
175 Second contact surface
176 Bottom mould insert
178 First upper contact surface
179 Second upper contact surface
180 Lip
300 Cut-out
302 Upper contacting surface
304 Connecting end
306 Upper surface
308 Lower surface
310 Upper half
312 Lower half
400 Tongue
401 Fixation point
402 Pin
403 Engagement area
500 Groove
501 Butterfly nut
503 Upright tongue
600 Activation medium
901-903 Bottom mould attachment arrangement
904-906 Bottom mould insert tongue
907-911 Bottom mould attachment arrangement by vacuum
912-913 Bottom mould attachment arrangement by magnetic force
SBM1, 2 Side basic mould
BM Bottom basic mould
CU Control unit
h1 Height at upper contacting surface
h2 Height at connecting end
l1 Length of lip
A, B Horizontal directions
C Vertical directions
E, F Horizontal directions inwards
G Vertical direction upwards
T, T1, T2 Width of tongue at the root and width of groove at the opening
T′, T1′, T2′
Width of tongue at the free end and width of the groove at the bottom
X Longitudinal direction
y Transverse direction
Z Vertical direction

1. A direct injection footwear mold assembly comprising:
two side basic molds, and
a bottom basic mold including a bottom mold attachment arrangement, the bottom basic mold having a transverse direction (y), a longitudinal direction (x) and a vertical direction (z), and the bottom mold attachment arrangement of the bottom basic mold being arranged to fixate a bottom mold insert in the vertical direction z to the bottom basic mold.

2. The direct injection footwear mold assembly according to claim 1, wherein each of the two side basic molds comprises a basic side mold and a respective side mold insert.

3. The direct injection footwear mold assembly according to claim 1, wherein each of the two side basic molds comprises a side mold attachment arrangement, the respective side mold attachment arrangements of the basic side mold being arranged to releasably fixate a respective side mold insert to the basic side mold.

4. The direct injection footwear mold assembly according to claim 1, wherein the bottom mold insert is 3D printed.

5.-7. (canceled)

8. The direct injection footwear mold assembly according to claim 1, wherein the bottom mold attachment arrangement of the bottom basic mold comprises at least two fixation points.

9. The direct injection footwear mold assembly according to claim 8, wherein a distance between at least one point of fixation, of the at least two fixation points, and a toe end of the bottom basic mold is less than 10 cm, and
wherein a distance between the at least one point of fixation and a heel end of the bottom basic mold is less than 10 cm.

10.-14. (canceled)

15. The direct injection footwear mold assembly according to claim 1, wherein the bottom mold attachment arrangement of the bottom basic mold comprises a plurality of fixation points forming part of continuous and/or sequentially arranged fixations points.

16. The direct injection footwear mold assembly according to claim 8, wherein the at least two fixation points are provided by guide rails by means of which the bottom basic mold and the bottom mold insert slide into each other, thereby providing a fixation of the bottom mold insert onto the bottom basic mold.

17. The direct injection footwear mold assembly according to claim 8, wherein the at least two fixation points are provided by a tongue of the bottom mold insert and a groove of the bottom basic mold, or vice versa, said tongue and said groove being configured for mutually fitting and being slidingly engageable.

18. The direct injection footwear mold assembly according to claim 17, wherein said tongue and said groove are configured having a width increasing towards a free end of the tongue.

19. The direct injection footwear mold assembly according to claim 17, wherein said tongue and said groove are configured with a taper in a direction of sliding engagement with each other.

20.-22. (canceled)

23. The direct injection footwear mold assembly according to claim 8, wherein the at least two fixation points are distributed in the longitudinal direction x and/or the transverse direction y of the basic bottom mold and the bottom mold insert.

24. The direct injection footwear mold assembly according to claim 8, wherein the at least two fixation points are distributed in the longitudinal direction x and/or the transverse direction y of the basic bottom mold and the bottom mold insert such that a distance to a medial and/or a lateral side of the basic bottom mold is at least 2 cm.

25. The direct injection footwear mold assembly according to claim 1, wherein the bottom mold attachment arrangement of the bottom basic mold is arranged to releasably fixate the bottom mold insert in the vertical direction z to the bottom basic mold.

26. A direct injection footwear bottom mold assembly comprising:
a bottom basic mold, and
a bottom mold insert,
wherein the bottom mold insert is releasably fixated to the bottom basic mold by means of an attachment arrangement.

27. The direct injection footwear bottom mold assembly according to claim 26, wherein the attachment arrangement is arranged to fixate the bottom mold insert in a direction perpendicular to the bottom basic mold.

28. A method of manufacturing footwear in a direct injection manufacturing station, the method including steps of:
providing two basic side molds and a bottom basic mold,
providing two side mold inserts and a bottom mold insert,
fixating the two side mold inserts to the respective two basic side molds and thereby providing/forming two side mold assemblies,
fixating the bottom mold insert to the bottom basic mold releasably by means of an attachment arrangement, the bottom mold insert and the bottom basic mold forming a bottom mold assembly,
mounting the two side mold assemblies and the bottom mold assembly to the direct injection manufacturing station, and
operating the direct injection manufacturing station.

29. The method according to claim 28, wherein the direct injection manufacturing station is operated by:
positioning a lasted upper of a footwear relative to the two side mold assemblies and the bottom mold assembly,
moving the two side mold assemblies and the bottom mold assembly relative to the lasted upper, thereby forming a sole volume confined by the two side mold assemblies, the bottom mold assembly, and the bottom of the lasted upper,
injecting direct injection material into the sole volume thereby molding a sole onto the bottom of the lasted upper of a footwear, and
moving the two side mold assemblies and the bottom mold assembly relative to the lasted upper and removing the lasted upper with the sole from the mold assembly.

30. The method according to claim 28, wherein the bottom mold insert (176) is releasably fixated to the bottom basic mold by slidingly engaging the bottom mold insert with the bottom basic mold.

31. The method according to claim 28, wherein the bottom mold insert is releasably fixated to the bottom basic mold by slidingly engaging a tongue of the bottom mold insert with a groove of the bottom basic mold or by slidingly engaging a groove of the bottom mold insert with a tongue of the bottom basic mold.

32. (canceled)
